(19) United States
(12) Patent Application Publication
(10) Pub. No.: US 2019/0299865 A1
(43) Pub. Date: Oct. 3, 2019

(54) AUXILIARY SIDE VIEW MIRROR AND METHOD OF USING THE SAME

(71) Applicant: Richard N. Bergman, Beverly Hills, CA (US)

(72) Inventor: Richard N. Bergman, Beverly Hills, CA (US)

(21) Appl. No.: 15/942,220

(22) Filed: Mar. 30, 2018

(51) Int. Cl. B60R 1/08; B60R 1/078; F16M 13/02; F16M 11/14; F16B 2/06

(52) U.S. Cl. CPC B60R 1/081; B60R 1/078; F16B 2/065; F16M 11/14; F16M 13/022

(57) ABSTRACT

An auxiliary side view mirror assembly is mountable to a cover portion of a conventional side view mirror as may be preinstalled on an outside of a variety of different automobiles. The assembly comprises a base configured to clamp onto a portion of the conventional side view mirror cover. A frontward portion of the base may form a ridge defining a mounting surface configured to retain a mirror. An auxiliary mirror may be set in a frame comprising a back side opposite a reflective surface of the auxiliary mirror, and an arm, securable to the mounting surface, may extend outward from the back side of the frame. When coupled to the mounting surface by way of the arm, the auxiliary mirror may be adjustable, relative to its mounted position, according to the needs of the driver and may be operative to reduce blind spots otherwise experienced by the driver.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to rear view mirror arrangements and, more particularly, to an auxiliary mirror assembly operative to reduce blind spots experienced by a driver which is securable near and adjustable independent of any side view mirror preinstalled on a wide variety of automobiles.

### BACKGROUND

Driving an automobile is well known to be a relatively dangerous endeavor at least in part because, in spite of the ubiquitous use of rear view mirrors, many areas surrounding the automobile are often obstructed from the driver's view. It may be particularly difficult to obtain a clear view of the areas directly beside and slightly behind and to the side of the vehicle. Even if it is possible to adjust preinstalled mirrors to afford a view of such areas, such adjustment is typically only performed in a manner that excludes the prior view. This is problematic since failure to detect objects and/or persons in these and other so-called blind spots can lead to damaging, and sometimes fatal, collisions with people and property. As a result, many attempts have been made to eliminate drivers' blind spots.

Some auxiliary or supplemental mirrors and mechanisms for mounting such mirrors have been proposed to solve the problem. Some automobiles, for instance, are equipped with digital cameras placed along their front, back and sides and a screen that displays camera inputs near the dashboard. Although these significantly reduce blind spots, they are expensive and may be difficult to install on older automobiles. As another example, some have proposed mounting an auxiliary mirror to a mirror that has been preinstalled on an automobile. However, deficiencies plague these proposed solutions as well. For instance, it has been suggested to adhesively mount an auxiliary mirror to a preinstalled mirror, such as a wing or side view mirror. The use of adhesive, however, may cause the auxiliary mirror to be difficult to reposition. In lieu of adhesive, some of these proposals disclose a variety of clamping mechanisms that directly contact, or otherwise interfere with, the preinstalled mirror and thus further obstruct any views reflected therein.

Thus, there remains a need for an improved auxiliary side view mirror.

### SUMMARY

The present disclosure is directed to an auxiliary side view mirror assembly that is mountable to a cover portion housing a conventional side view mirror which may be preinstalled on an outside of a variety of different automobiles. In particular, the auxiliary mirror may be adjustable, relative to its mounted position, as desired and may be operative to reduce blind spots otherwise experienced by the driver.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the auxiliary side view mirror assembly comprises a base and means for securing the base to a portion of the side view mirror cover. For the sake of clarity, conventional side view mirrors, also known as a wing mirrors, fender mirrors, door mirrors, or outside rear-view mirrors, may be mounted within the cover to define some space between such mirror and cover along all sides of the mirror, enabling the mirror to be electrically or manually adjusted to a certain degree while avoiding interference with such adjustment. Accommodating mirror adjustments as such may provide a diverse range of drivers with adequate viewing options, depending, for example, on each individual's height and seating position. Thus, in some embodiments, the base may be defined by a top and a bottom plate spaced apart to receive a portion of the conventional side view mirror cover therebetween, without undesirably interfering with possible adjustment of the side view mirror.

A frontward portion of the base, which joins the top and bottom plates, may form a ridge defining a mounting surface configured to support an auxiliary mirror. In some embodiments, the auxiliary mirror may be set in a frame comprising a back side opposite a reflective surface of the mirror, and an arm securable to the mounting surface may extend outward from such back side of the frame.

In some embodiments, the bottom plate may define a hole configured to securely receive a threaded fastener, such as a screw, which itself is operative to engage with the hole and press the cover between the top and bottom plates. In this manner, it is contemplated that the cover may be bolted, or clamped as the case may be, between the top and bottom plates. An additional washer may be disposed between a head or knob portion of the threaded fastener and the bottom plate to distribute the load of the threaded fastener and further prevent such fastener from gradually becoming loose while the auxiliary side view mirror assembly is mounted to the conventional side view mirror. Alternatively, or additionally, the head or knob of the threaded fastener may be broad relative to its threaded portion to distribute the load of the threaded fastener and prevent loosening over time. Examples of such fasteners may be a cap screw or a hex bolt.

Various means for securing the arm of the frame to the mounting surface of the base are contemplated. For instance, in one embodiment, the arm extending outward from the back side of the frame may be formed as a terminal ball. Likewise, the mounting surface may comprise a socket configured to receive such a ball. Thus, the ball and socket may enable the base and framed mirror to be rotatably coupled to one another. One skilled in the art will recognize that a variety of ball and socket configurations may be selected to ensure that the mirror may be rotatable relative to the base and also lockable in a desirable position so that the driver may experience a relatively constant view of the particular area, relative to the automobile, that the driver so chooses.

Thus, it is an object of the invention to provide an auxiliary mirror for attachment to a conventional mirror typically installed on an outer side of a variety of automobiles.

It is another object of the invention to provide such a mirror operative to reduce a driver's blind spots.

It is still another is an object of the invention to provide a readily adjustable auxiliary mirror.

It is even yet another object of the invention to provide a readily removable and replaceable auxiliary side view mirror assembly.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of the auxiliary side view mirror assembly in accordance with one embodiment of the invention.

FIG. 2 shows an exploded view of the auxiliary side view mirror in accordance with one embodiment of the invention.

FIGS. 3 and 4 illustrate a method of using the auxiliary side view mirror in accordance with one embodiment of the invention.

The disclosed embodiments may be better understood by referring to the figures in the attached drawings, as provided below. The attached figures are provided as non-limiting examples for providing and enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

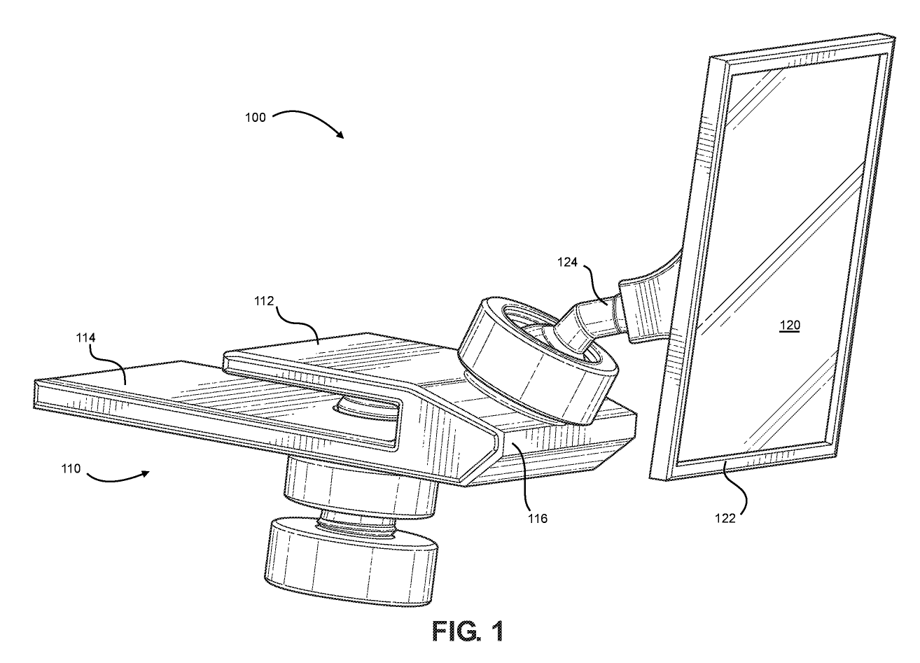

With reference to FIG. 1 an embodiment of the mirror assembly 100 may comprise a base 110 having a top plate 112 and a bottom plate 114 extending parallel to one another from a ridge 116. The ridge 116 may define a mounting surface 118 configured to support an auxiliary mirror 120 secured within a frame 122, such as by adhesion or snap fit elements. An arm 124 may extend from the frame 122 so that when mounted on a side view mirror cover, such as, for example, any of those typically preinstalled on a variety of automobiles, the auxiliary mirror 120 may be spaced apart from any plane defined by such side view mirror, preventing undesirable damage to such mirror and/or the assembly 100. In some embodiments, the arm 124 may be jointed, as shown in the pictures, as well.

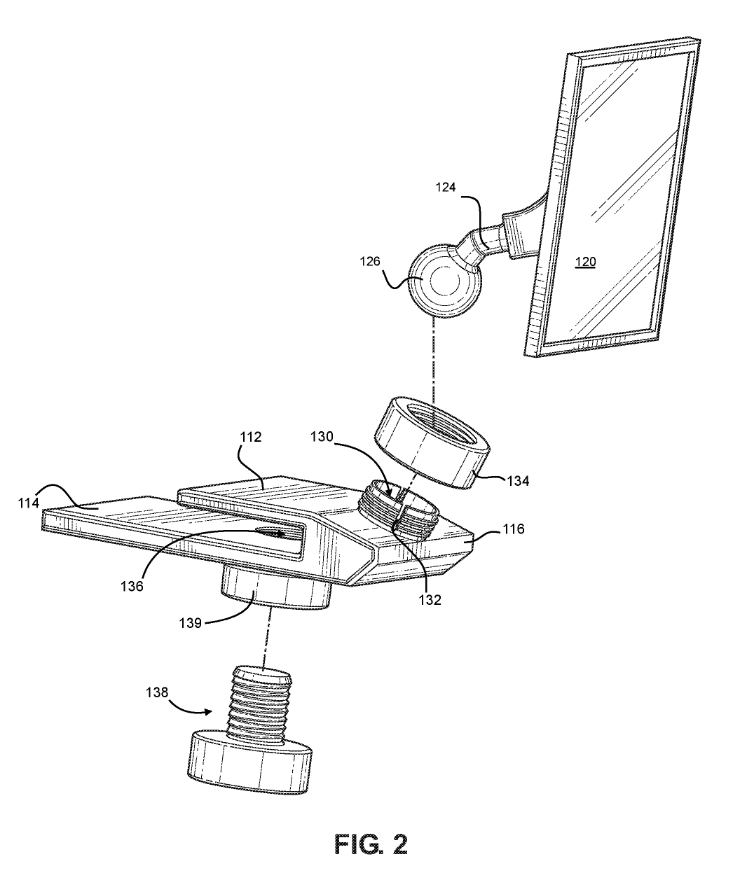

Means for rotatably coupling the auxiliary mirror 120 to the base 110 are also provided. In the figures, exemplary means for coupling the auxiliary mirror 120 comprise a socket 130 disposed on the mounting surface 118 and a ball 126 situated at a terminal portion of the arm 124, which may be more clearly observed in FIG. 2. In some embodiments, the socket 130 may be outwardly threaded and configured to define at least one vertical notch 132. In some embodiments, the socket 130 may define two vertical notches 132, though one skilled in the art will recognize that the socket may comprise more as well without departing from the invention. Providing such notches may enable portions of the socket to be compressed around the ball 126 to forcibly squeeze such joint, and consequently, the auxiliary mirror 120, into a locked position when in use. In some embodiments, the ball 126 may rotate freely until a tightening nut 134 is threadedly engaged with the socket 132 to compress the socket 126 around the ball 126. It should be noted that one or more washers may also be provided to prevent the nut 134 from coming loose while the auxiliary side view mirror assembly is in use.

In some embodiments, the ridge 116 may be angled downward relative to the top plate 112 in order to position the mounting surface out of the way of a preinstalled side view mirror when in use and also make the nut 134 more easily accessible to a user wishing to manipulate such nut 134. It is contemplated that positioning the mounting surface out of the way of a preinstalled side view mirror in this manner may decrease the risk of physically interfering with or otherwise touching the side view mirror and also enable a beneficially broad range of rotation of the auxiliary mirror 120. Indeed, this broad range of rotation could allow a user to view previously unviewable blind spots. For example, it may be known to those skilled in the art that the rotation of a preinstalled mirror may be limited by the presence of any machinery housed behind such mirror in the side view mirror cover. This limitation may frequently prevent the preinstalled mirror from being rotated sufficiently downward to reflect objects on the ground directly beside the vehicle. Such a view may be particularly desirous while a driver is, for example and not limitation, parking and wishes to ensure that any wheels on his or her vehicle remain within and/or parallel to parking guidelines painted or otherwise disposed on the ground. As another example, such a view may be particularly desirous over the course of parallel parking along a curb. Indeed, failing to accurately judge one's vehicle's distance from a curb may result in damage to one's hub caps and/or wheels and fenders, in the event that one positions too close to a curb and brings his or her vehicle into contact with such curb. In the event that one misjudges and parks too far from a curb, of course, the driver risks obtaining a citation or ticket for obstruction of traffic. Thus, one skilled in the art will recognize that arranging the auxiliary side view mirror assembly as discussed may beneficially aid users attempting to park their vehicles in accordance with parking guidelines and/or when faced with certain obstructions.

Other means for rotatably coupling the auxiliary mirror to the base are also contemplated. For instance, some ball and socket joints may be secured in a desired position by way of screws or pins engagable through the socket to bolt the ball in place. Some others may be compression and/or tension loaded to maintain the ball in a desired position. Therefore, the foregoing is offered by way of example only and not limitation.

In some embodiments, certain elements comprising the auxiliary side view mirror assembly may be fabricated from rugged, molded or even three-dimensionally printed plastic. For example, only and not limitation, any of the base 110, frame 122, arm 124, and securing the auxiliary side view mirror assembly 100 to a side view mirror cover preinstalled on a vehicle (such means discussed in further detail below) may comprise molded or even three-dimensionally printed polyamide, polypropylene, polyvinyl chloride, polystyrene, acrylonitrile butadiene styrene, among other materials, including combinations of the same. In some embodiments, elements of auxiliary mirror 120 may be fabricated from metal and/or glass.

One embodiment of means for securing the auxiliary side view mirror assembly to a side view mirror cover preinstalled on a vehicle is also shown in FIG. 2. More particularly, the bottom plate 114 of the base 110 may define a hole 136 configured to receive a threaded fastener therethrough. The threaded fastener may be a bolt 138 having a blunt end operative to clamp a portion of a conventional, preinstalled side view mirror between the top and bottom plates 112, 114 of the base 110, and effectively secure the auxiliary mirror 120 to a conventional side view mirror known to those skilled in the art. Providing a bolt having a blunt, rather than rounded or even pointed end, may prevent damage to the clamped portion of the side view mirror. In some embodiments, a washer may be used to prevent the bolt 138 from coming lose from the bottom plate 114. However, it is also contemplated that a stopper member 139 may be disposed in line with the hole 136 defined by the bottom plate 114 as well.

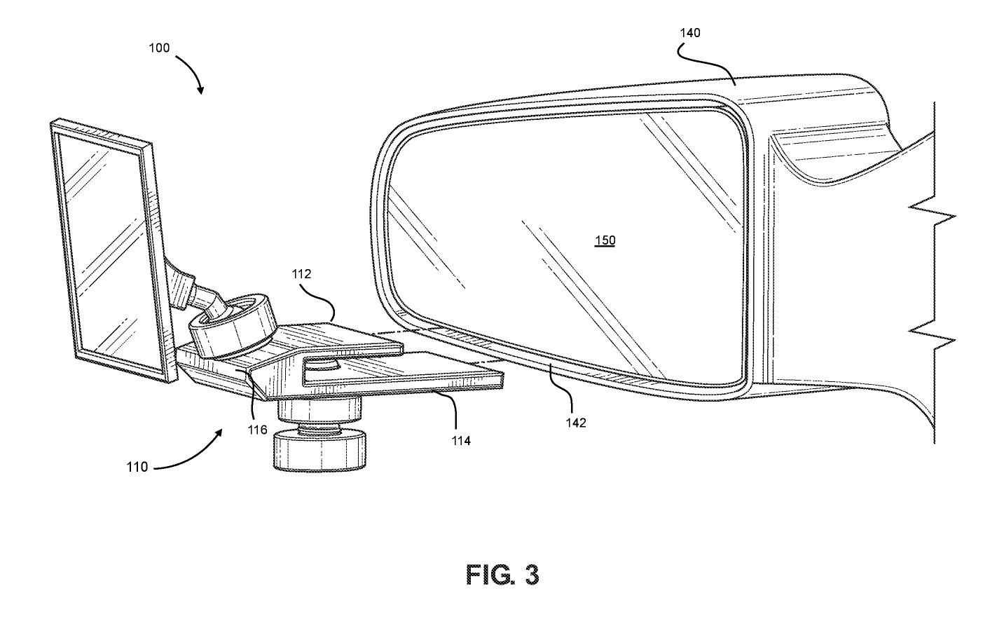

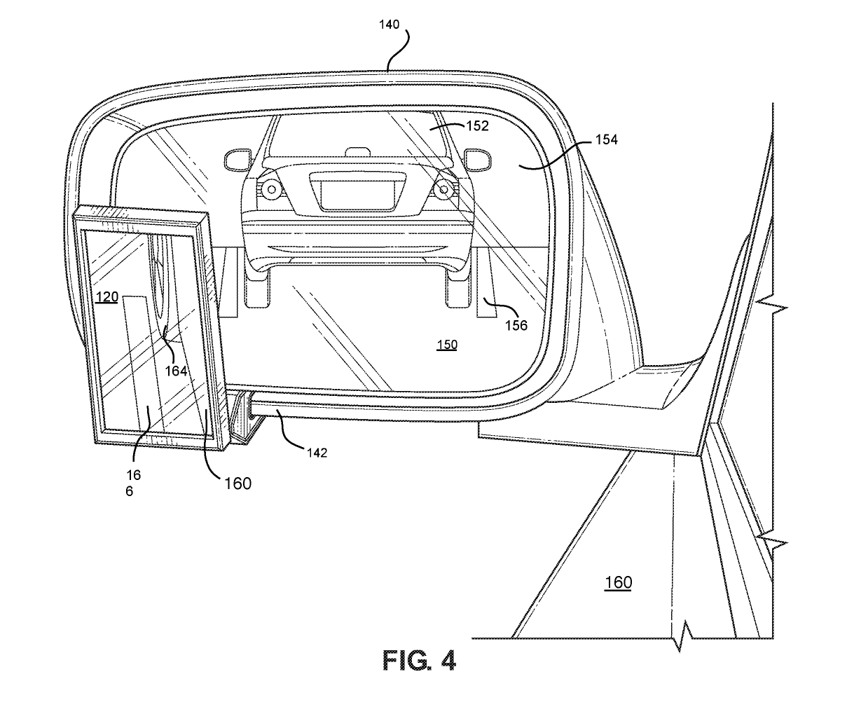

Providing a threadable fastener such as the bolt 138 may allow a driver or other user to reposition the auxiliary side view mirror assembly along the cover as desired. Thus, the threaded fastener may, in other words, function as means for repeatedly securing and releasing the auxiliary side view mirror assembly to the cover as desired. Indeed, it is even contemplated that the same auxiliary side view mirror assembly may be removed from one cover altogether and instead be mounted to another side view mirror cover. For example, an auxiliary side view mirror may be easily removed from a mounted position on a driver's first automobile to a mounted position on his or her second automobile. As another example, an auxiliary side view mirror may be easily removed from a driver's side of an automobile to a passenger's side of an automobile. This may be done with no fear that the means securing the auxiliary side view mirror assembly to a side view mirror cover has lost its strength. As such, the auxiliary side view mirror assembly 100 may be mountable to a cover 140 portion of a conventional side view mirror 150 as may be preinstalled on an outside of a variety of different automobiles, as shown in FIGS. 3 and 4.

One exemplary method of using the auxiliary side view mirror assembly 100 may comprise sliding the top and bottom plates 112, 114 of the base around the cover 140 of the side view mirror 150, tightening the bolt 138 to firmly secure the cover 140 therebetween, rotatably adjusting the auxiliary mirror 120 as desired, and tightening the nut 134 around the socket 130 to secure the auxiliary mirror 120 in place. Although the assembly is shown being mounted to a bottom edge 142 of the cover in FIG. 3, it should be understood that the auxiliary mirror may alternatively be mounted to a top edge, or even side edge, if the shape of the cover permits it. This configuration ensures that the auxiliary mirror 120 may be adjustable according to each driver's individual preference, which may depend, for example, on the driver's height and seat position, and is operative to reflect a wide range of otherwise blind views outside of his periphery.

It should be noted that in some embodiments, the bottom plate 114 may extend further from the ridge 116 than the top plate 112. The length of the top plate 112 may even be limited by the presence of a motor or other side view mirror adjustment mechanism housed with the side view mirror 150 within the cover 140. However, one skilled in the art will recognize that providing a relatively longer bottom plate 114 may increase stability of the assembly 100 in its mounted state. This configuration may distribute the moment of force loaded under the weight of the auxiliary mirror 120 and frame 122 on the assembly 100 along a corresponding surface area.

With reference to FIG. 4, it will be apparent to one of ordinary skill in the art that the auxiliary mirror 120 is operative to reduce some of a driver's typical blind spots. For instance, FIG. 4 shows a reflection of some objects—namely, another vehicle 152, wall 154, and parking guidelines 156—that correspond with the area behind the driver's own automobile 160. In comparison, the auxiliary mirror 120, installed at a downward angle relative to the side view mirror 150, is shown to be reflecting different objects—namely, the ground directly beside the driver's own automobile, the driver's own tire 164 and automobile side body 160, as well as a parking guideline 166—that correspond with an area alongside the automobile. As such, a driver may obtain a view of any parking guidelines to more easily park their car within a space, as the case may be. Of course, it is contemplated that the driver may optionally adjust the auxiliary mirror 120 to reflect other possible blind spots, and thus the foregoing is offered by way of example only and not limitation. Indeed, in some embodiments, the auxiliary mirror 120 may define a convex curve to reflect a broader area, relative to the area reflected by a standard mirror, and further reduce a driver's blind spots.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the shape of the auxiliary mirror and assembly frame may vary, as well as the particular placement of such assembly on the side view mirror cover. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the auxiliary side view mirror assembly and method of using the same with which that terminology is associated. In general, the terms used in the following claims should not be constructed to limit the auxiliary side view mirror assembly and method of using the same to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the auxiliary side view mirror and method of using the same is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method apparatus are contemplated in any number of claim forms. Thus, the inventor reserves the right to add additional claims after filing the application to pursue such additional claim forms for other aspects of the auxiliary side view mirror assembly and method of using the same.

What is claimed is:

1. An auxiliary side view mirror assembly, comprising:
a base defined by a top plate and a bottom plate extending parallel to one another from a ridge defining a mounting surface and spaced apart from one another to receive a portion of a side view mirror cover therebetween;
a mirror secured within a frame having a backside, an arm extending from the back side of the frame;
means for rotatably coupling the auxiliary mirror to the base via the arm extending from the frame;
means for securing the arm of the frame to the mounting surface of the base; and
means for securing the base to a portion of the side view mirror cover;

2. The mirror assembly of claim 1, wherein the base defines a hole and means for securing the auxiliary mirror in a selected position comprises a threaded fastener operative to engage such hole and releasably clamp the top and bottom plates around the cover.

3. The mirror assembly of claim 2, wherein the threaded fastener is a bolt having a blunt end.

4. The mirror assembly of claim 1, wherein the means for rotatably coupling the auxiliary mirror to the base via the arm extending from the frame and means for securing the arm of the frame to the mounting surface of the base comprise:
a ball disposed on a terminal end of the arm,
an outwardly threaded socket defining at least one vertical notch disposed on the mounting surface; and
a nut operative to threadably engage the socket;
wherein such socket is configured to receive the ball and such nut is operative to compress the socket around the ball to lock the ball into a selected position.

6. An auxiliary side view mirror assembly, comprising:
a base defined by a top plate and a bottom plate extending parallel to one another from a ridge defining a mounting surface angled downward relative to the top plate, the top and bottom plates spaced apart from one another to receive a portion of a side view mirror cover therebetween, the bottom plate defining a hole operative to receive a threaded fastener;
a mirror secured within a frame having a backside, a bent arm extending from the back side of the frame and terminating in a ball;
an outwardly threaded socket defining at least one vertical notch and disposed on the mounting surface, such socket configured to receive the ball;
a nut operative to threadably engage the socket and compress the socket around the ball to lock the ball into a selected position; and
means for repeatedly securing and releasing the auxiliary side view mirror assembly to the cover.

7. A method of reducing an automobile driver's blind spot, comprising:
retrieving an auxiliary side view mirror comprising,
a base defined by a top plate and a bottom plate extending parallel to one another from a ridge and spaced apart from one another to receive a portion of a side view mirror cover therebetween;
a mirror secured within a frame having a backside, an arm extending from the back side of the frame;
means for rotatably coupling the auxiliary mirror to the base via the arm;
means for securing the auxiliary mirror in a selected position; and
a threaded fastener operative to releasably clamp the top and bottom plates around the cover;
sliding the top and bottom plates of the base around a portion of the cover;
tightening the threaded fastener to firmly secure the cover between the top and bottom plates;
rotatably adjusting the auxiliary mirror in its coupled arrangement to reflect matter as desired; and
engaging the means for securing the auxiliary mirror in the selected position.

8. The method of claim 7, wherein the adjusting step comprises rotating the auxiliary mirror downward to reflect any ground or surface present directly alongside the vehicle as viewable by a driver seated in the vehicle.
